(19) United States
(12) Patent Application Publication
(10) Pub. No.: US 2025/0010442 A1
(43) Pub. Date: Jan. 9, 2025

(54) Tool for Windshield Removal

(71) Applicant: Cory Avary, Odessa, TX (US)

(72) Inventor: Cory Avary, Odessa, TX (US)

(21) Appl. No.: 18/744,220

(22) Filed: Jun. 14, 2024

Related U.S. Application Data
(63) Continuation-in-part of application No. 17/962,522, filed on Oct. 9, 2022, now abandoned.

(51) Int. Cl. B25B 27/00; B25F 5/02; B62D 65/06

(52) U.S. Cl. CPC B25B 27/0028; B25B 27/0035; B25F 5/02; B62D 65/06

(57) ABSTRACT

A reciprocally operable tool for enabling removal of a vehicle windshield from a vehicle body adjacent to the windshield is disclosed. Also disclosed is a method for converting a reciprocally operable saw into a reciprocally operable tool to remove a vehicle windshield.

### REFERENCE TO RELATED APPLICATION

This patent application is a continuation-in-part (“CIP”) of US nonprovisional patent application Ser. No. 17/962,522 filed Oct. 9, 2022, hereby incorporated by reference in its entirety for purpose of priority pursuant to Title 35, United States Code, Section 120.

### FIELD

The present subject matter is directed, in general, to a vehicle windshield removal tool, and more particularly, to a vehicle pane removal tool possessing reciprocating action.

### BACKGROUND

Many different windshield removal tools are well known. For instance, U.S. Pat. No. 3,448,517 to Cothery discloses a tool to cut through material used to seal around edges of an automobile windshield so the windshield can be removed. The tool includes a knife having a handle and a puller arm pivotally connected to the handle to aid in pulling a blade of the knife through the material. Included is a heater to heat the blade to assist in cutting.

U.S. Pat. No. 5,622,093 to Hutchins discloses a windshield removal apparatus having a suction cup assembly vacuum-secured to an interior central portion of an automobile windshield. A swivel head is located at an opposite end of the assembly where a vacuum interface is initiated. The swivel head rotates bidirectionally 360 degrees in about the same plane as that of the windshield. Swivel head rotation is said to be relatively friction free. A spring is located between the swivel head and the cutting wire. The wire, attached to a grip, completes the apparatus configuration. The cutting wire is initially threaded through a seal between the windshield and automobile. Connection of the cutting wire to the spring and swivel head may take place in any order, so that the apparatus is in an appropriate position to commence a cutting process of the entire perimeter of the seal. The cutting process involves pulling and releasing the cutting wire in a series of motions, where the spring and swivel head work in conjunction to aid in the cutting process. After separating the seal perimeter, the windshield is removed from the automobile structure.

U.S. Pat. No. 5,826,342 to Zuro discloses a vehicle windshield removing tool including a handle for gripping by the tool user, and a blade extending from the handle for insertion between the vehicle windshield and the vehicle or a gasket holding the windshield. The blade includes a base portion, mounted in the handle in a way as to extend outwardly from the handle, and a cutting portion formed into an inverted U-shaped terminal end that is used to cut the adhesive or bonding material between the windshield and the molding by sliding the U-shaped terminal end about the perimeter of the windshield, with its windshield edge positioned, and thereafter slid, within the U-shaped portion of the blade.

U.S. Pat. No. 5,953,802 to Radzio discloses a windshield jack having a linear actuator operable between a retracted position and an extended position. The actuator includes telescoping inner and outer tubes. A reversible drive motor connected to the outer tube includes a threaded drive shaft engaging the inner tube, a base member to position on a front seat of a vehicle, and a windshield contact member to engage the windshield. Motor rotation in one direction moves the inner tube for extending the actuator. Motor rotation in the opposite direction moves the inner tube to retract the actuator. The base member could be a straight crossbar, a foot pad, or a bowed crossbar. The windshield contact member may be a crossbar, a suction cup, or a crossbar with suction cups fixed along it.

U.S. Pat. No. 6,178,645 to Lock discloses a device for severing a bonding strip located between and securing together two rigid panels, one of which may be of glass. The device has a flat elongated blade adapted and configured to be inserted between the panels for the purpose of severing the bonding strip. The device includes a rest mechanism adapted to sit on one of the panels being separated to guide reciprocation of the elongated blade, whereby the blade reciprocates in a direction parallel to the panel that is being separated.

U.S. Pat. No. 7,874,074 to Rodriguez-Vega discloses a tool to assist a worker in removing a windshield. The tool includes a cylindrical housing having an L-shaped blade that extends from a lower end of the blade. The housing includes a butane-fueled heating assembly to heat the blade to a predetermined temperature, so the blade can penetrate any adhesive surrounding the vehicle windshield. A handle, tethered to the housing by a cable, allows a worker to easily lift the windshield after the adhesive has been separated.

U.S. Pat. No. 10,227,965 to Mayhugh discloses a pane of glass removal tool for cutting through an adhesive bead with a wire. The tool comprises a suction cup, and a vacuum pump connected to the suction cup and communicating with an interior of the cup. The tool includes a housing with a cam rotatably mounted therein for periodically operating the pump. The housing is mounted on the vacuum pump. The tool also includes a spool coaxial with and rotatably connected to the cam, and a stem connected to one of the cam and the spool. The stem is adapted and configured to rotate the stem and cam.

U.S. Pat. No. 11,738,475 to Boehmer et al. discloses a windshield removal tool having an elongate arm with a claw at its distal end. The device includes a winch actuated by a motor at the proximal end of the arm. When a cutting wire is positioned along an adhesive bead about a periphery of a fixed glass or panel, the wire is threaded through a puncture in the adhesive bead and attached to the winch. The claw engages a location along the adhesive bead as the winch draws in the wire while a pulley near the distal end of the arm guides the wire. The device may be moved from a first anchored position, and anchored at a new position, by removing the claw and placing it at another point along the periphery.

My review of such prior art, while informative, suggests that an apparatus designed and adapted for more efficient removal of windshields from vehicles would be desirable.

Many reciprocally functioning tools are known. For instance, U.S. Pat. No. 6,851,193 to Bednar et al. discloses a reciprocating saw comprising a housing, a motor, a spindle movably supported within the housing and having a front end adapted to support a saw blade, a drive assembly, and an adjustable shoe assembly. The adjustable assembly includes a shoe, a shoe support member adapted to pivotally support the shoe, a locking member pivotally supported by the housing, and a lever connected to the locking member.

U.S. Pat. No. 7,168,169 to Moreno discloses a so-called anti-rotation reciprocating drive apparatus for a reciprocating saw. The drive apparatus has a wobble plate assembly including a drive shaft and an elongated arm with an interface structure for engaging a spindle. The interface structure includes two ball-type interfaces concentrically aligned with one another. The outer interface is smaller than the inner. Both interfaces engage a receiver portion of the spindle. The larger inner ball-type interface causes reciprocating movement of the spindle, and the smaller outer interface prevents rotation of the spindle. The contact surface between the interfaces and spindle receiver is a single point contact, for reducing operating friction and wear of parts, and for dissipating any heat generated.

US 2022/0118534 to Zhang et al.—hereby incorporated by reference in its entirety—discloses a reciprocating saw including a housing and a functional assembly. The functional assembly includes a motor supported by the housing. The reciprocating saw also includes a sliding rod for connecting and driving the saw blade. The reciprocating saw also includes a transmission mechanism connecting the motor and the sliding rod for driving the sliding rod to reciprocate. The reciprocating saw includes a connecting device configured to rotatably connect the functional assembly to the housing. The reciprocating saw also includes a buffer arranged between the functional component and the housing.

US 2022/0118534 discloses a reciprocating saw 100 (see FIGS. 1 through 3) which comprises a housing 110 and a functional assembly 200. The functional assembly 200—which implements a cutting function for reciprocating saw 100—includes a motor 210, a sliding rod 220, and a transmission mechanism 230. The sliding rod 220 is configured to connect and drive a saw blade to cause a saw blade (FIG. 5) alternately to move back and forth. Motor 210 is supported by housing 110. Moreover, there is a gap, or an elastic element (not shown), disposed between the motor 210 and housing 110. Transmission mechanism 230—connecting motor 210 to sliding rod 220—causes sliding rod 220 to reciprocate (i.e., causes the sliding rod 220 alternately to move back and forth). The reciprocating saw 100 includes a connecting device 120 and a buffer 130. The connecting device 120 is configured to rotatably connect the functional assembly 200 to housing 110.

Connecting device 120 (FIG. 3) is rotatable about a central axis extending along a first straight line 103. (FIG. 5.) The buffer 130 (FIG. 2) is positioned between the functional assembly 200 and housing 110. (FIG. 1.) While the reciprocating saw 100 is operational, motor 210 drives sliding rod 220 to reciprocate (i.e., alternately to move back and forth) along a first direction 101 and a second direction 102 (FIG. 3) through the transmission mechanism 230. The buffer 130, positioned between the assembly 200 and the housing 110, buffers the functional assembly 200, thereby reducing any impact force between the functional assembly 200 and housing 110 and reducing any vibration of the housing 110.

In US 2022/0118534, the connecting device 120 (FIGS. 2, 3) includes a rotating member 121 and a fixed member 122. (FIG. 5.) The fixed member 122 is securely coupled to the functional assembly 200. (FIG. 2.). Also, rotating member 121 (FIG. 5) is securely coupled to the housing 110. (FIG. 1.) The fixed member 122 is provided with a pin hole (not shown), so that the functional assembly 200 is rotatable about the first straight line 103 relative to housing 110. The fixed member 122 may be securely coupled to the housing 110 (FIG. 1), and the rotating member 121 (FIG. 5) may be securely coupled to the functional assembly 200. Fixed member 122 and rotating member 121 (FIG. 5) May be securely coupled to each other along first straight line 103 so that there is no relative displacement between them. The buffer 130 (FIG. 2), which may be made of an elastic material, may be positioned between the fixed member 122 and the rotating member 121.

US 2022/0118534 also discloses that the transmission mechanism 230 (FIG. 2) includes a transmission gear 231 (FIG. 3), a counterweight 232 (FIGS. 3, 4) and a first eccentric structure 233 (FIG. 3). Motor 210 (FIGS. 2, 4) has a motor shaft 211 along a first axis 105. (FIG. 3.) The transmission gear 231 is engaged with the motor shaft 211, in order to be driven to rotate by the motor 210. The counterweight 232 is coupled to the transmission gear 231. The first eccentric structure 233 connects the sliding rod 220 and the transmission gear 231. The transmission gear 231 can drive the sliding rod 220 to reciprocate along the first direction 101 and the second direction 102 through the first eccentric structure 233. The counterweight 232 moves in the second direction 102 opposite to first direction 101 when sliding rod 220 slides in the first direction 101. The sliding rod 220 moves in the first direction 101, and the counterweight 232 moves in the second direction 102 opposite to the first direction 101. Meanwhile, the transmission gear 231 (FIG. 3) imparts a pull force to the sliding bar 220 in the second direction 102 and a pull force to the counterweight 232 in the first direction 101. Due to the reaction force, the transmission gear 231 generates a torque to lift the entire front end of the transmission mechanism 230 upward. The first eccentric structure 233 (FIG. 3) includes a transmission member 2331. (FIG. 4.) The transmission member 2331, positioned on one side of the transmission gear 231, is eccentrically connected to the transmission gear 231. (FIG. 3.)

A guiding rail 221 (FIG. 4), oriented perpendicular to first direction 101, is provided on one side of the sliding rod 220 (FIG. 3). In this way, when the reciprocating saw 100 (FIGS. 1-3, 5) is operational, the rotating transmission member 2331 (FIG. 4) is moving in the guiding rail 221 along a direction perpendicular to the first direction 101 (FIG. 3), to drive the guiding rail 221 and cause the sliding rod 220 to move in the first direction 101 and the second direction 102, which results in reciprocating (i.e., back-and-forth) motion.

The transmission mechanism 230 includes a transmission shaft, driven by the transmission gear 231, which may be engaged by or coupled to transmission gear 231. Transmission mechanism 230 also includes a second eccentric structure 250. (FIG. 4.) The transmission gear 231 (FIG. 3) is coupled to counterweight 232 (FIGS. 3, 4) through the second eccentric structure 250. When the sliding rod 220 moves in the first direction 101, the second eccentric structure 250 drives the counterweight 232 to move along the second direction 102 opposite to the first direction 101. The second eccentric structure 250 includes a cam 251 (FIG. 4) fixed to one end of the transmission shaft. Cam 251 is eccentrically connected to the transmission shaft. Counterweight 232 is provided with a guiding hole 2321. (FIG. 4.) Cam 251, rotating in guiding hole 2321, drives counterweight 232 to reciprocate in the first direction 101 and the second direction 102. Sliding rod 220 may be positioned on an upper side of the transmission gear 231, and counterweight 232 may be positioned on a lower side of transmission gear 231. An axial distance between the counterweight 232 and sliding rod 220, when oriented along the second straight line 104, may range between about 10 mm and about 18 mm. As a person of ordinary skill is aware, the greater the distance between the counterweight 232 and the sliding rod 220, the longer the “arm-of-force” (i.e., moment arm) and, thus, the greater the imposed torque will be, resulting in an increased cutting efficiency of reciprocating saw 100. (FIGS. 1-3.)

US 2022/0118534 also discloses that to ensure a “compact” feature for the reciprocating saw 100 (see FIGS. 1-3), a distance between counterweight 232 and sliding rod 220 should not be too long, be rather should be a length predetermined to be suitable for a job reciprocating saw 100 is to perform. Also, the first axis 105, along which the motor shaft 211 of motor 210 is oriented, may itself be oriented parallel to the first direction 101. Also, projections of the counterweight 232 and motor 210 that are oriented radially from the first direction 101 may be partially overlapped. Also, the second straight line 104 may extends in an up-and-down direction from-and-toward the reciprocating saw 100. When reciprocating saw 100 is operational, the buffer 130 may be elastically deformable at least in a direction of the second straight line 104, which may be perpendicular to the first straight line 103. The buffer 130, which may be positioned above and below the moving components, may be formed of one, or a combination of, a sponge, a rubber, and a spring. US 2022/0118534 further discloses that the reciprocating saw 100 also includes a sleeve for supporting and positioning the sliding rod 220. (FIG. 3.) The sliding rod 220, positioned through the sleeve, is restricted by the sleeve to extend along the first direction 101, so that the sliding rod 220 is driven by a transmission mechanism 230 (FIG. 2) to reciprocate (i.e., respectively move back-and-forth) along the first direction 101 and the second direction 102. The functional assembly 200 (FIG. 2) also includes a gear box 240 (FIG. 3) for supporting the transmission mechanism 230. A portion of the transmission mechanism 230, as well as the sleeve, is located within the gear box 240. (The fixed member and the rotating member are fixedly coupled with the gear box and the housing respectively.) A portion of transmission mechanism 230 is fixedly coupled to the gear box 240 so that the entire transmission mechanism 230 synchronously rotates along with gear box 240, with the buffer 130 positioned between the gear box 240 and the housing 110.

In the vehicle windowpane removal trade, it would be desirable for there to be a commercially available reciprocating tool designed and adapted for vehicle pane removal.

### SUMMARY

The present subject matter is directed to an apparatus, mechanism, or tool that I refer to as a “Glass Rebel” (TRADEMARK). The Glass Rebel apparatus, mechanism, or tool is a quick-connect, reciprocating, auto-glass (i.e., vehicle-windshield) removal tool which includes a plurality of custom-designed stainless-steel blades. Each blade has a substantially flat working end portion and an integral hexagonal end portion opposite the working end portion. The apparatus, mechanism, or tool of the present subject matter also includes a simple but effective design equipped with a 7/16-inch hex quick-connect feature that makes it easy to switch-out blades as well as position blades for all those hard-to-reach angles and/or locations between a windowpane and the body of a vehicle. With a shortened stroke length (i.e., a maximum reciprocal movement) of ⅜ inch, this tool would be deemed perfect (i.e., highly desirable) for auto glass (vehicular windshield) removal by a person of ordinary skill in the art (“POSITA”) in this field. The tool design also features a powerful (conventional) brushless direct-current (“DC”) motor paired with a (conventional) 5-amp lithium-ion battery. The Glass Rebel apparatus, mechanism, or tool further includes vibration-dampening rubber—designed, dimensioned, adapted, and configured to provide a smoother cut through material securing a windshield to a vehicle. The current tool design also does away with any need for a conventional sheath which has been found to often damage vehicle dashes and shorten the useful life of a normal glass removal blade by rubbing the base and weakening the blade base, costly over time.

Currently there are five blade designs, each designed to cover a situation most likely to be encountered by a person seeking to remove a windshield from a vehicle. The blades include a long blade, a medium blade, a short blade (preferred dimensions of these blades are disclosed below), and two panel blades: 1 & ½-inch wide and 1-inch wide. The 1-inch blade is best for “trimming up” (i.e., removing) essentially all urethane material in a “pinch weld” region on a vehicular body next to windowpane edge portions.

Each blade is sized, adapted, and configured to be easily, seamlessly, and quickly removably secured to a “working end portion” of the Glass Rebel apparatus, mechanism, or tool of the present subject matter because of a quick-connect feature that the tool has.

After the working end portion of a blade is secured to the quick-connect feature (i.e., structure) of the tool, the blade remains secured to the quick-connect structure of the tool and isn't removed by a forceful pull of the blade from the quick-connect structure. Therefore, the blade doesn't become separated from the tool while a tool user is cutting.

The quick-connect feature (i.e., the quick-connect structure) includes a slide. To remove a blade secured to the quick-connect structure, a tool user simply pulls back the slide and then pulls the blade hexagonal end portion out from the quick-connect structure.

As a person of ordinary skill in the art (“POSITA”) can appreciate, the hexagonal geometry of the quick-connect structure in relation to the hexagonal geometry of the end portion of each of the five blades enables a tool user to select one out of six angled blade orientations, relative to a work area (e.g., pane or vehicle), for an ordinarily awkward cut. The blades are each made of a 420 stainless steel. The blades have been engineered, heat-treated, and manufactured to be ductile, i.e., to have an edge portion that conforms to the curvature of a windshield while being moved around along the windshield by a user of the mechanism or tool of the present subject matter, to create a smooth and clean cut.

Each blade includes a hexagonal end portion opposite its blade end portion. The hexagonal end portion enables each blade to be secured at each of the six angled blade orientations, relative to a work area, and quickly insert into and extract from the tool itself.

A prototype of the apparatus, mechanism, or tool of the present subject matter was extensively tested by several professional vehicle windowpane removal technicians. When comparing the prototype of the present subject matter to known auto-glass removal tools, the tool prototype of the present subject matter was essentially always favored by these auto-glass removal technicians due to its compact, powerful, and versatile design.

### BRIEF DESCRIPTION OF THE DRAWING FIGURES

FIG. 1 is a perspective view of a prior art reciprocating saw, without a saw blade.

FIG. 2 depicts a side view of the prior art of FIG. 1, showing internal components.

FIG. 3 is a side view of the prior art of FIG. 1, showing other internal components.

FIG. 4 is a side elevational perspective view, depicting components of the prior art reciprocating saw in operational engagement, on an enlarged scale relative to FIGS. 1-3.

FIG. 5 is a sectioned perspective view of the prior art of FIG. 1, with a saw blade.

FIG. 6 is a side elevational view of an assembly of internal components of the prior art reciprocating saw presented in FIG. 3, with its blade guard spaced from the assembly.

FIG. 7 is a side elevational view resembling FIG. 6, illustrating a method for transforming a reciprocating saw into a reciprocating apparatus, mechanism, or tool for removing a windshield from a vehicle, in accordance with the present subject matter, wherein the method comprises cutting the blade guard of the prior art reciprocating saw.

FIG. 8 is a side elevational view resembling FIGS. 6 and 7, illustrating the method for transforming a reciprocating saw into the reciprocating apparatus, mechanism, or tool for removing a windshield of a vehicle, in accordance with the present subject matter, wherein the method includes attaching a panel cut from the blade guard to the assembly.

FIG. 9 is a partially exploded side elevational view of several gear components of the assembly of internal components of the prior art reciprocating saw depicted in FIG. 2.

FIG. 10 is an exploded side elevational view of several more gear components of the assembly of internal components of the prior art reciprocating saw depicted in FIG. 2.

FIGS. 11A and 11B present a prior art cam vis-à-vis a custom stroke-reducing cam adapted, dimensioned, and configured for use in a reciprocating apparatus, mechanism, or tool to remove a windshield of a vehicle, in accordance with the present subject matter.

FIG. 12 is an exploded view of several components (including the custom-made cam depicted in FIG. 11B) for operative use within the gear mechanism housing shown.

FIG. 13A is an exploded view showing the custom stroke-reducing cam of FIG. 11, and other components cooperating with the custom cam, to produce reciprocating motion; and FIG. 13B is an assembled view of a bearing, a gear, and the cam shown in FIG. 13A.

FIGS. 14A and 14B illustrate steps of a method for transforming a reciprocating saw into a reciprocating apparatus, mechanism, or tool for removing a vehicle windshield, in accordance with the present subject matter, by substituting a quick-connect coupling (FIG. 14B) for a prior art saw blade connector of the assembly (FIG. 14A) shown in FIG. 6.

FIG. 15 is a side elevational view depicting a method for converting a reciprocating saw into a reciprocating apparatus, mechanism, or tool for removing a vehicle windshield, in accordance with the present subject matter, by securing a quick-connect coupling assembly of the present subject matter to a shaft of a prior art assembly shown in FIG. 6.

FIG. 16 is an enlarged end view of the quick-connect coupling depicted in FIG. 15.

FIG. 17 depicts a side elevational view illustrating an additional step of a method for converting a prior art reciprocating saw into a reciprocating apparatus, mechanism, or tool for removing a vehicle windshield, in accordance with the present subject matter, by moving an embodiment of the quick-connect coupling assembly of the present subject matter (as illustrated by FIG. 15) toward a shaft of a prior art assembly (shown in FIG. 6).

FIG. 18 presents a side elevational view illustrating a method for transforming a reciprocating saw into a reciprocating apparatus, mechanism, or tool for removing a windshield from a vehicle, in accordance with the present subject matter, by securing the quick-connect coupling illustrated by FIG. 15 to a shaft of an assembly shown in FIG. 6.

FIG. 19 is a side elevational view of an embodiment of a reciprocating apparatus, mechanism, or tool for removing a windshield of a vehicle, in accordance with the present subject matter, for which most of the internal components of the embodiment are visible.

FIG. 20 presents the embodiment (shown in FIG. 19) as it would appear to a user.

FIG. 21 is a side elevational view of the reciprocating mechanism or tool shown in FIG. 20 before a blade that has been designed, sized, adapted, and configured to remove a vehicle windshield is joined to the quick-connect coupling assembly shown in FIG. 15.

FIG. 22 is a side elevational view of the reciprocating mechanism or tool shown in FIG. 20 after a blade that has been designed, sized, adapted, and configured to remove a vehicle windshield is joined to the quick-connect coupling assembly shown in FIG. 15.

FIG. 23 displays a preferred embodiment of differently shaped and sized blades 12 designed, adapted, and configured for use with the reciprocating apparatus, mechanism, or tool for removing a vehicle windshield, in accordance with the present subject matter.

FIGS. 23A, 23B, and 23C depict another embodiment for blade stems of FIG. 23.

FIGS. 24A, 24B, 24C, and 24D include a series of views, showing the reciprocating apparatus, mechanism, or tool of the present subject matter in use by a vehicle windshield removal technician, for separating a lower portion of the windshield from the vehicle body.

Throughout the FIGS. and the detailed description of this patent application, similar reference numerals are used to refer to similar components of the present subject matter.

### DETAILED DESCRIPTION

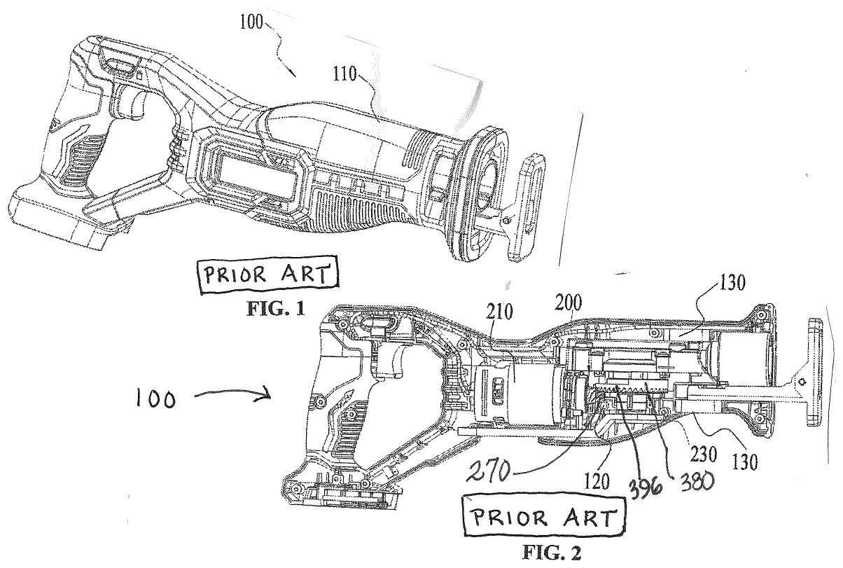

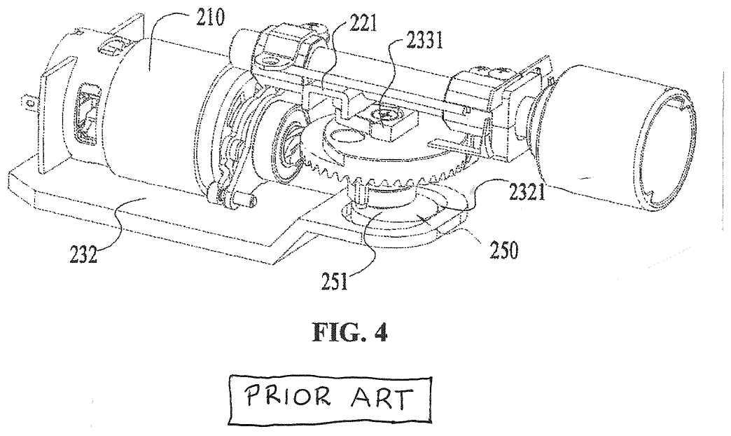

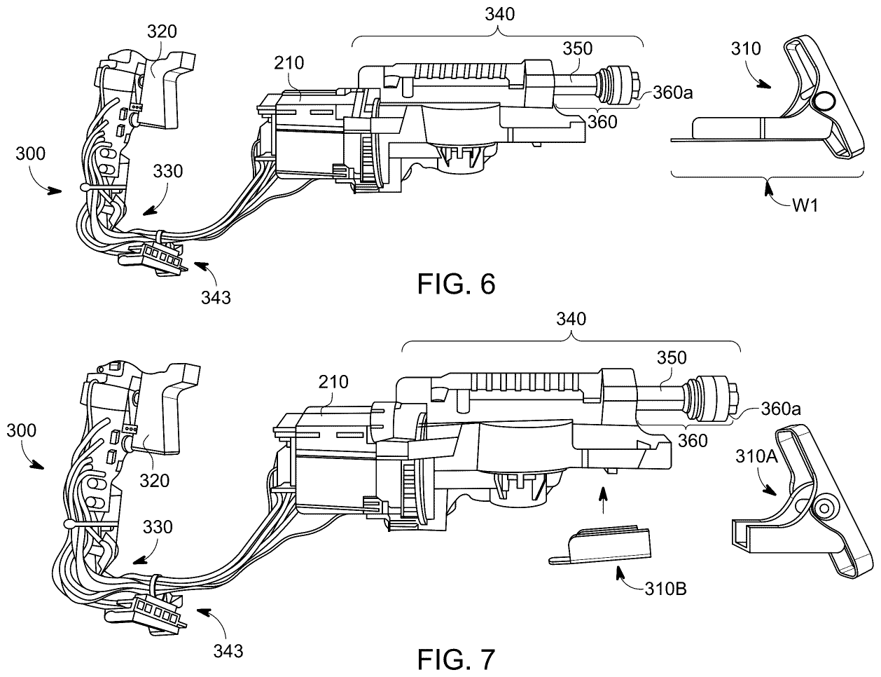

Please refer to FIGS. 6 through 8 for a visual description of how the reciprocating saw described in connection with FIGS. 1 through 5 can become an embodiment of a reciprocating apparatus, mechanism, or tool of the present subject matter. FIG. 6 depicts a side elevational view of an assembly of internal components 300 of the prior art reciprocating saw presented in FIG. 3, with its blade guard 310 now shown as removed from the assembly of internal components 300 and spaced from the right side thereof. The assembly of internal components 300 includes the motor 210 (described above), a trigger 320, and a wiring harness 330 operatively connecting the trigger 320 to motor 210. The harness 330 includes a conventional 20-volt lithium-battery hook-up connector 343.

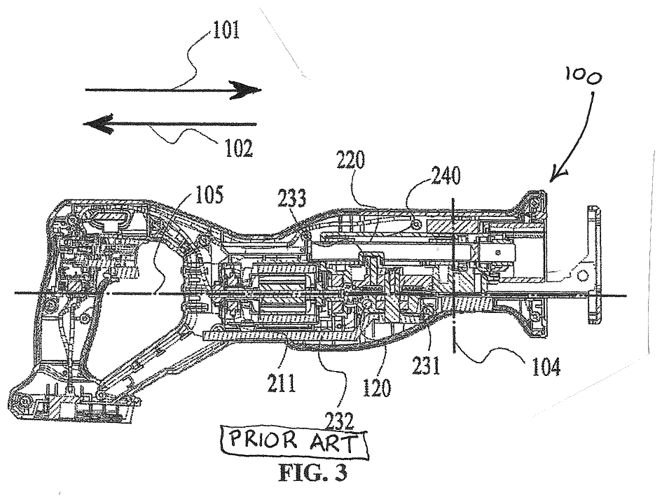

Operably connected to an output shaft (not shown) of motor 210 is a reciprocating-action assembly 340 including an output shaft 350 and a coupling 360a. After the trigger 320 has been returned to a handgrip portion of its housing (see FIGS. 1, 2) and the trigger squeezed to operate the motor 210, a greater squeezing pressure increases reciprocating action of the shaft 350 and a lesser squeezing pressure reduces the reciprocating action.

FIGS. 6, 7 are side elevational views illustrating a step of a method for transforming a reciprocating saw into a reciprocating apparatus, mechanism, or tool for removing a vehicle windshield, in accordance with the present subject matter. With the blade guard 310 removed from the assembly of internal components 300, as shown in FIG. 6, a predetermined location along the width (“W1”) of blade guard 310 is selected for cutting the blade guard 310 (FIG. 6) into a blade guard portion 310A and an endcap portion 310B, as shown in FIG. 7. A width for the endcap portion 310B is carefully selected to securely cover an opening along an underside (not shown) of reciprocating-action assembly 340.

FIG. 8 is a side elevational view further illustrating the method for transforming a reciprocating saw into a reciprocating apparatus, mechanism, or tool to remove a vehicle windshield, in accordance with the present subject matter. The method includes the step of attaching endcap portion 310B to the underside of reciprocating-action assembly 340.

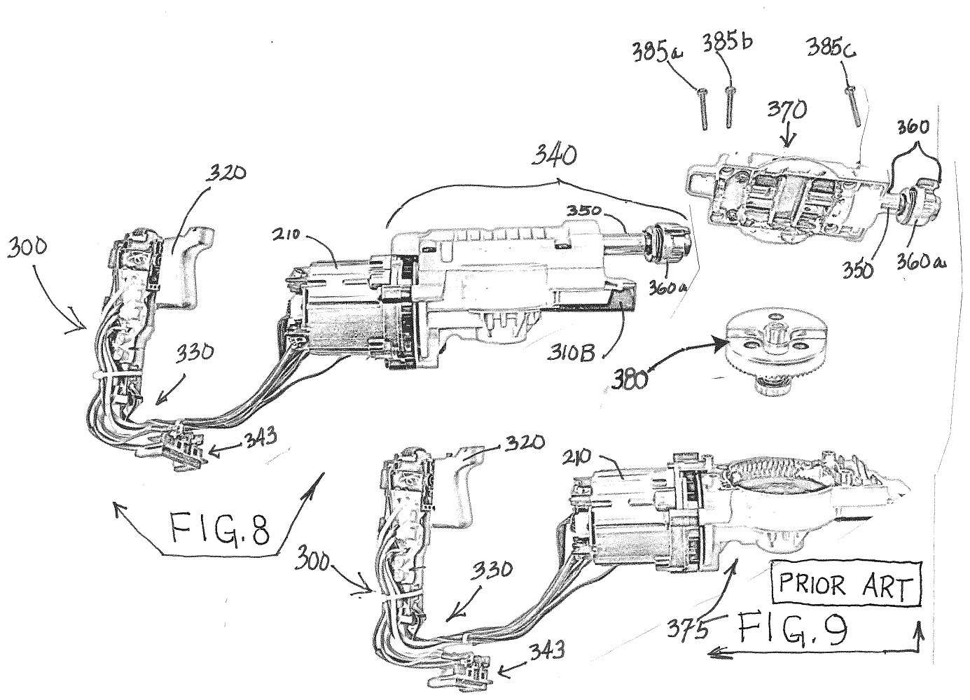

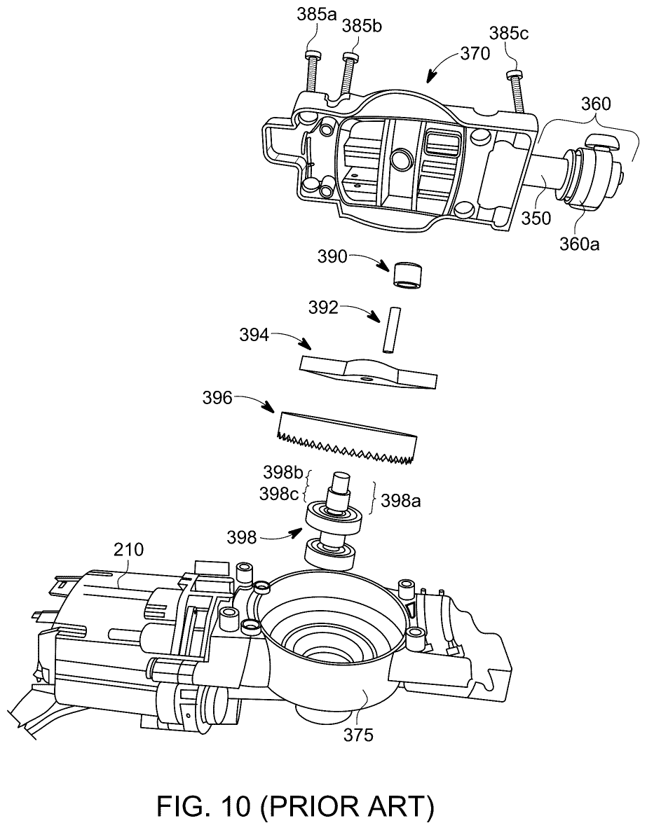

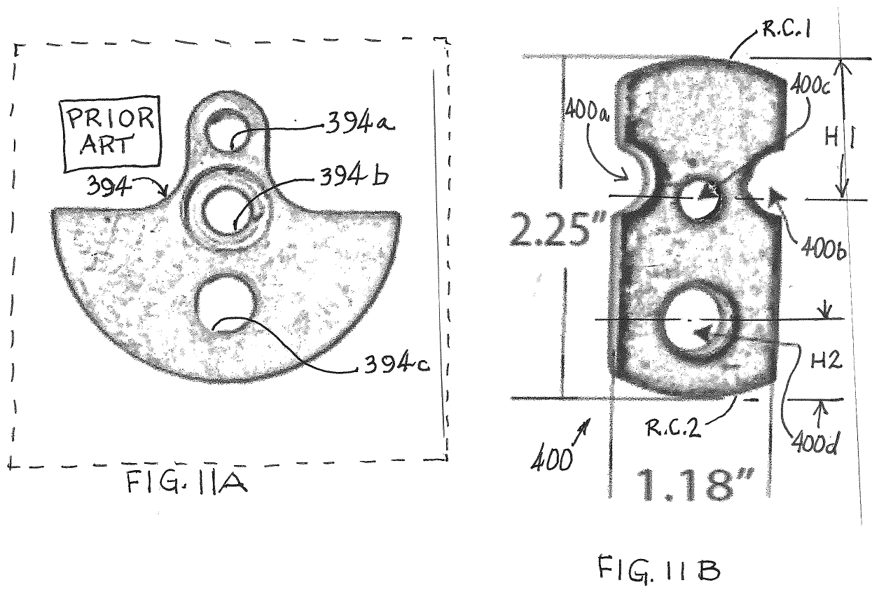

FIG. 9 is a partially exploded side elevational view of several gear components of an assembly of internal components of the reciprocating saw (see FIG. 2). FIGS. 9, 10 depict an upper gear housing 370, within which a mechanism to power the shaft 350 is retained as well as a lower gear housing 375 connected to the motor 210. FIG. 9 shows a prior art gear-and-cam assembly 380, while FIGS. 9 and 10 show several machine-screw threaded fasteners 385a, 385b, 385c. A fourth fastener (not shown) enables the several fasteners, collectively, to be used to removably secure the upper and lower gear housings 370, 375 together with the gear-and-cam assembly 380 disposed therebetween.

FIG. 10 is an exploded side elevational view of several more gear components of the assembly of internal components of the prior art reciprocating saw (shown in FIG. 2). The exploded view of FIG. 10 shows a needle bearing 390, a bearing shaft 392, a prior art cam 394, a main gear 396, and a bearing assembly 398. The gear-and-cam assembly 380 shown in FIG. 9 includes the prior art cam 394 and main gear 396 shown in FIG. 10.

FIGS. 11A, 11B show a prior art cam vis-à-vis a custom-made stroke-reducing cam adapted, dimensioned, and configured for use in a reciprocating apparatus, mechanism, or tool for removing a vehicle windshield, in accordance with the present subject matter. The prior art cam 394 (introduced above in relation to FIG. 10) includes three apertures 394a, 394b, and 394c. A first aperture 394a through the prior art cam 394 is dimensioned to receive the bearing shaft 392 (also introduced above in relation to FIG. 10). Referring briefly to FIG. 10, the main gear 396 includes a central aperture (not shown). The bearing assembly 398 includes an integral extension 398a disposed through the central aperture (not shown) of main gear 396 and through a second aperture 394b of prior art cam 394. A third aperture 394c through prior art cam 394 is used to access a screw (not shown).

In operation, motor 210 of prior art reciprocating saw 100 (FIG. 2), when energized, rotates a drive gear 270 about an axis of an output shaft (not shown) of the motor 210. Drive gear 270 is securely fixed to the output shaft of motor 210. The gear teeth of drive gear 270 engage the teeth of driven main gear 396. Rotation of the output shaft (of motor 210), in turn, causes main gear 396 and prior art gear-and-cam assembly 380 to rotate about a second axis, oriented transverse to the axis about which drive gear 270 rotates.

FIG. 11B depicts a custom cam 400, in accordance with the present subject matter. A preferred embodiment of the custom-made cam 400 of the present subject matter is generally rectangular and has a predetermined thickness. The custom-made cam 400 has a width of about 30 millimeters (about 1.18 inches) and a height of about 57.2 mm (about 2.24 inches). The custom-made cam 400 includes an upper curved surface having a first radius of curvature (R.C.1) of about 28.6 mm (about 1.125 in.) and a lower curved surface opposite the upper curved surface. The lower curved surface has a second radius of curvature (R.C.2) also of about 28.6 mm (about 1.125 in). The custom-made cam 400 includes a first side notch 400a and a second side notch 400b located opposite the first side notch 400a. Each notch 400a, 400b is sized and used to access a screw (not shown).

The custom-made cam 400 of the present subject matter includes two apertures 400c, 400d. The first aperture 400c is sized to receive the bearing shaft 392 (FIG. 10). The second aperture 400d of the custom-made cam 400 is sized and used to access a screw (not shown). A preferred embodiment of the first aperture 400c of the custom-made cam 400 of the present subject matter has a diameter of about 6.4 mm (about 0.25 in.) In a preferred embodiment of the custom-made cam 400, the second aperture 400d has a diameter of about 12.7 mm (about 0.5 in.) and the first and second side notches 400a, 400b each have an inner radius of curvature of about 6.4 mm (about 0.25 in.). The preferred embodiment of the custom cam 400 also has a first height (H1) from the center of the first aperture 400c to the top of the custom cam 400, which measures about 26.7 mm (about 1.05 in.) and a second height (H2) from the center of the second aperture 400d to the bottom of custom cam 400, which measures about 14.6 mm (about 0.575 in.).

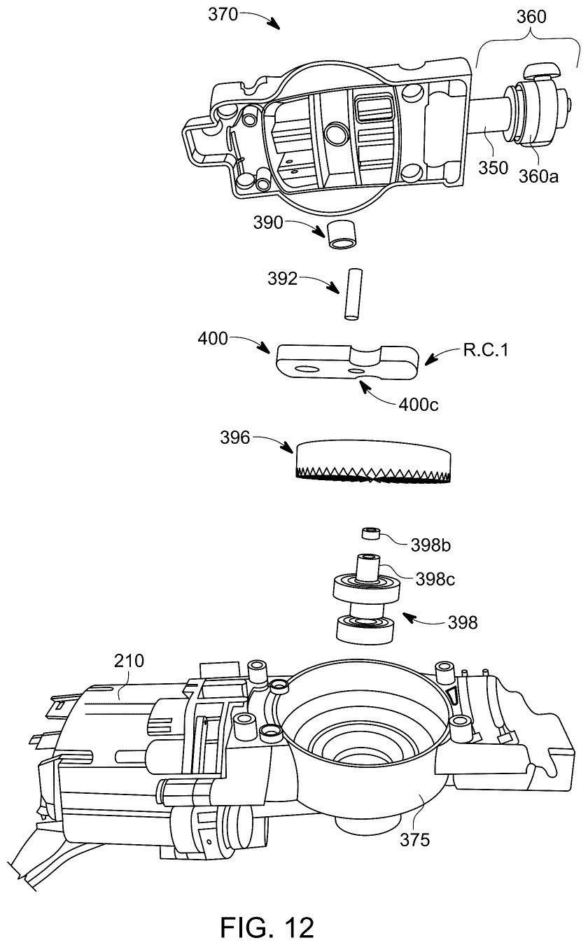

FIG. 12 depicts an exploded and vertically oriented presentation of an assortment of components including custom-made cam 400 described above and shown in FIG. 11B for operative use within the gear mechanism housing that FIG. 12 depicts. Returning now briefly to FIG. 10, recall that bearing assembly 398 includes an integral extension 398a.

The extension 398a has an upper portion 398b and a lower portion 398c unitary with the upper portion 398b. Upper and lower portions 398b, 398c are both cylindrical and the upper portion 398b has a diameter that is less than the diameter of lower portion 398c.

FIG. 12 illustrates an embodiment of the method for transforming a reciprocating saw (described in detail above and illustrated by FIGS. 1-5) into the reciprocating apparatus, mechanism, or tool for removing a vehicle windshield, in accordance with the present subject matter. One step of the method is to sever the upper portion 398b from the lower portion 398c of bearing assembly extension 398a, leaving bearing assembly 398 with only its integral lower portion 398c. Another step is to reduce the length of bearing shaft 392 by a predetermined amount to enable a reduced length version of bearing shaft 392 to be pressure fit into the first aperture 400c of custom cam 400 while achieving a tight fit between the various adjacent components shown in FIG. 12 when assembled, for enabling the custom-made cam 400 to be welded to the main gear 396.

In illustrated embodiments, a distance from the center of first aperture 400c to the uppermost portion of the first (or upper) radius of curvature (R.C.1) of custom-made cam 400 is about 4.8 mm (about 3/16 in.), to achieve a stroke of about 9.5 mm (about ⅜ in.). Yet and in sharp contrast, the stroke of the prior art reciprocating blade saw 100 discussed in detail above (and illustrated in FIGS. 1 through 3) is about 28.6 mm (about 1.125 in.).

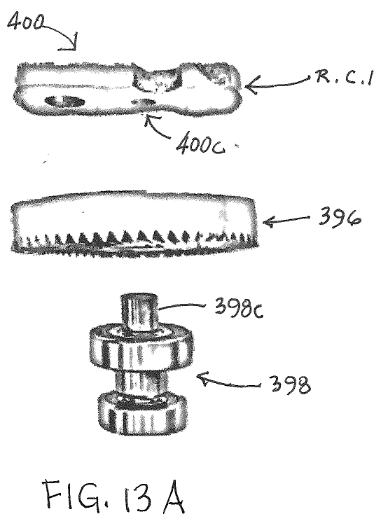

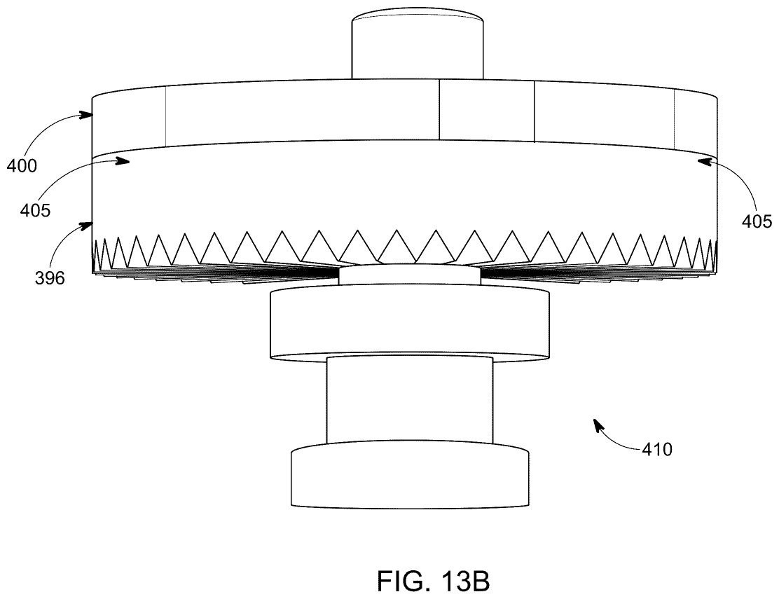

FIG. 13A is an exploded and vertically oriented presentation of the custom-made stroke-reducing cam 400 described in detail in relation to FIG. 11, including various other components that cooperate with the custom-made stroke-reducing cam 400, to produce the reciprocating motion described herein. Moreover, FIG. 13B is a side elevational view depicting a gear-and-cam assembly 410 consisting of the components shown in FIG. 13A.

Components used to make gear-and-cam assembly 410 (FIG. 13B) include bearing assembly 398 and its integral projecting portion 398c, main gear 396, the custom-made stroke-reducing cam 400, a length-reduced version 392a of bearing shaft 392 (originally depicted in FIGS. 10 and 12), and needle bearing 390. The gear-and-cam assembly 410 was manufactured by press-fitting together the components identified in the preceding sentence using a hydraulic press to do so and next welding custom-made stroke-reducing cam 400 to main gear 396 entirely along the perimeter of their abutting edge margins 405.

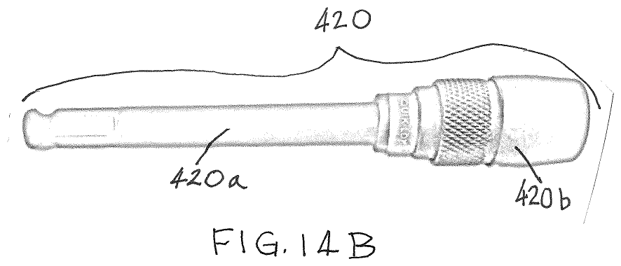

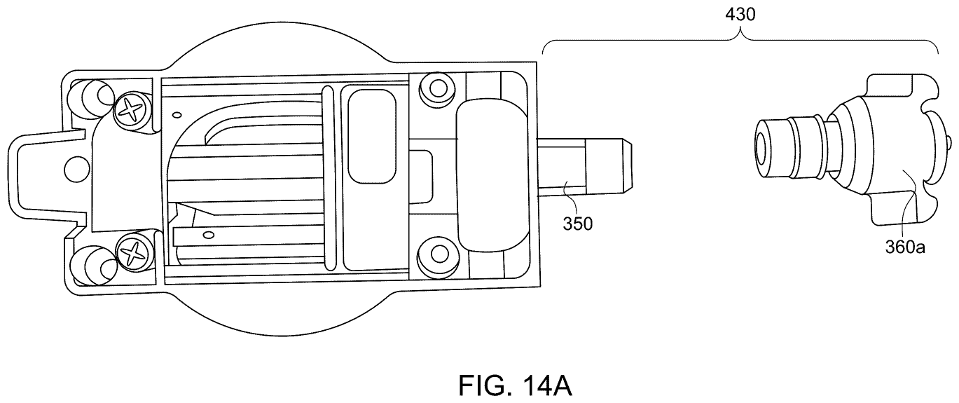

FIGS. 14A and 14B show additional steps of a method to transform a reciprocating saw 100 (FIGS. 1-3) into a reciprocating apparatus, mechanism, or tool for removing a windshield from a vehicle, in accordance with the present subject matter. For instance, an additional step involves substituting a quick-connect coupling assembly 420 (FIG. 14B) for a prior art saw blade connector assembly 360, originally depicted in FIGS. 6 and 7. Briefly, one step of the method would be to sever the coupling 360a from output shaft 350 (compare FIGS. 6, 7 to FIG. 14A) and then make, from quick-connect coupling assembly 420 (presented in FIG. 14B), a new assembly within a region 430 (depicted in FIG. 14A).

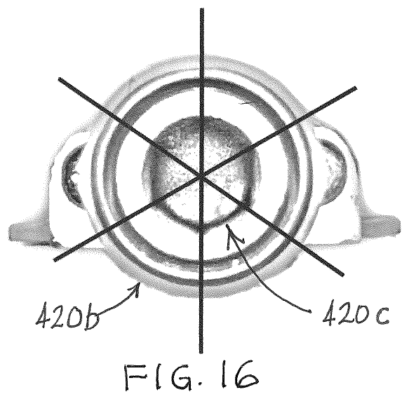

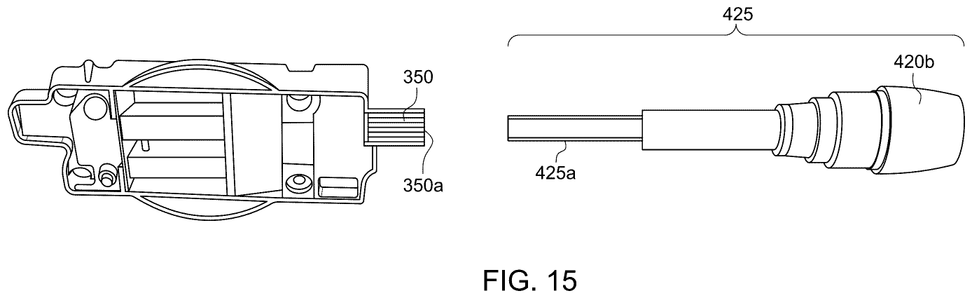

FIG. 15 presents a side elevational view illustrating additional steps involving a method for transforming a reciprocating saw into a reciprocating apparatus, mechanism, or tool for removing a vehicle windshield, in accordance with the present subject matter. For instance, the output shaft 350 of the prior art reciprocating saw 100 (FIGS. 1-3) is hollow. Therefore, to fit an end portion of a shaft 420a of the quick-connect coupling assembly 420 (FIG. 14B) into the hollow of the output shaft 350, all except for a two-inch (50.8-mm) portion (adjacent to a quick-connect coupling 420b) of coupling assembly 420 (FIG. 14B) is size-reduced to a predetermined width, e.g., about 9.4 mm (about 0.37 in.).

After the end portion of shaft 420a (FIG. 14B) of quick-connect coupling assembly 420 is reduced in size to the value noted above, preferably by a lathe, the size-reduced end portion 425a snugly fits into a central hollow 350a (FIG. 15) of output shaft 350. Thus, an end-portion size-reduced quick-connect coupling assembly 425 (FIG. 15) replaces the prior art saw blade connector assembly 360 (FIGS. 6, 7) within region 430 (FIG. 14A).

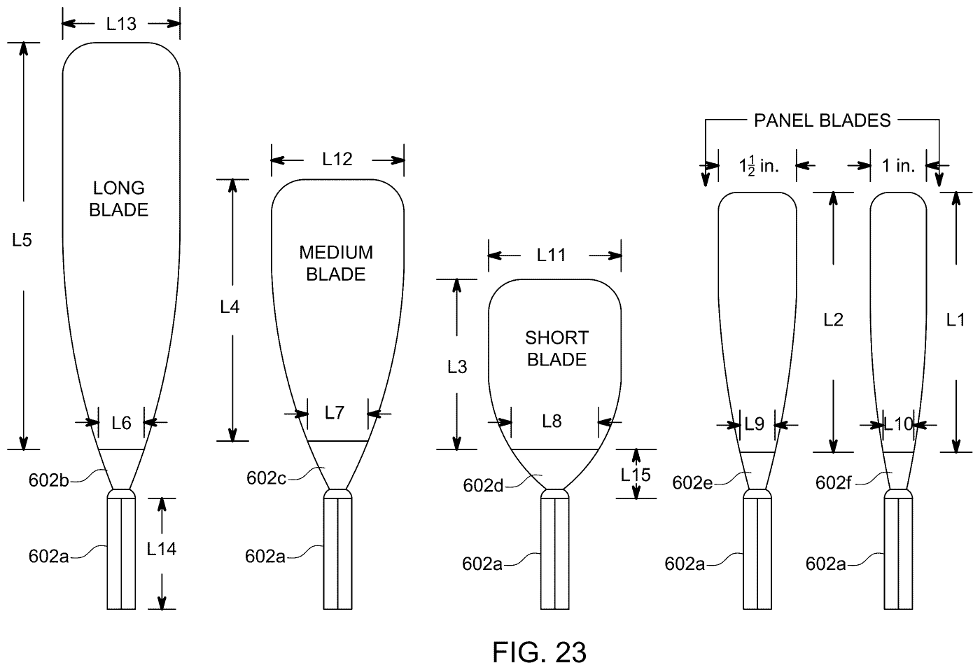

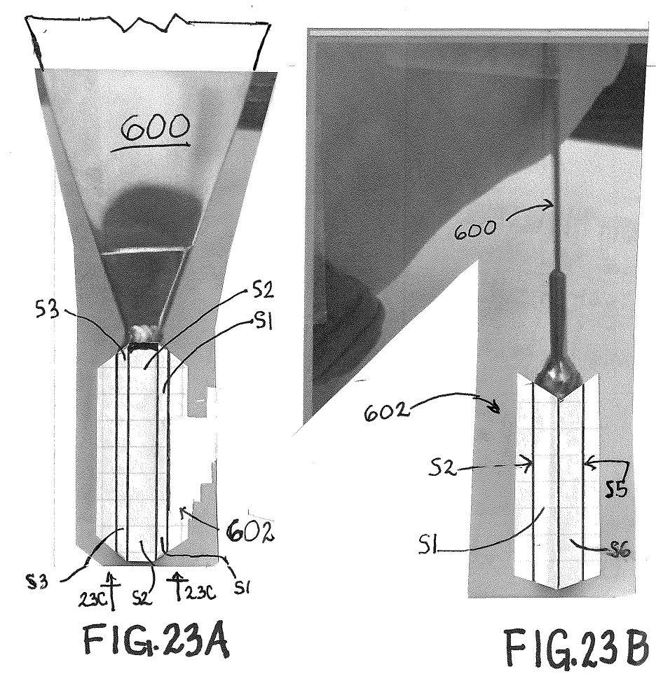

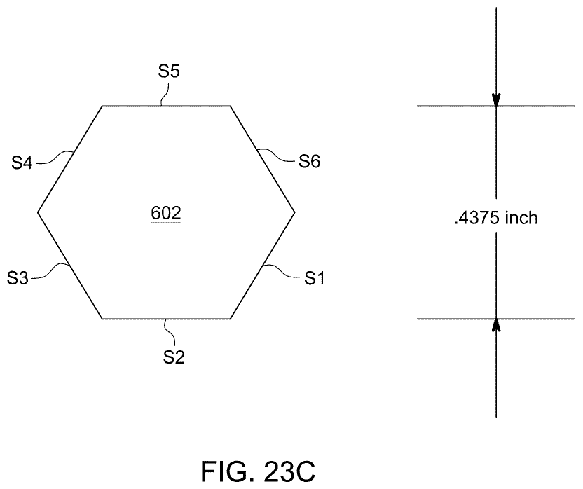

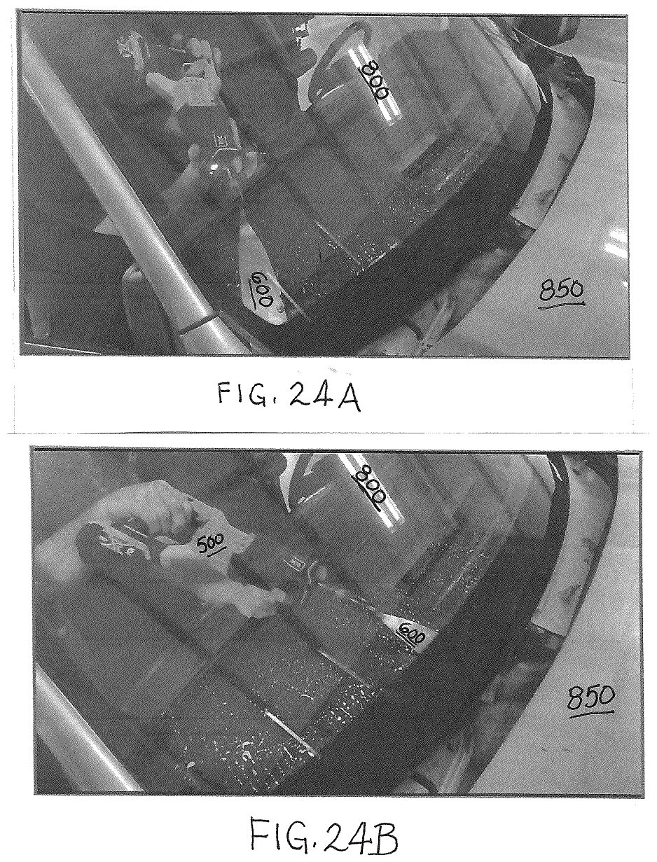

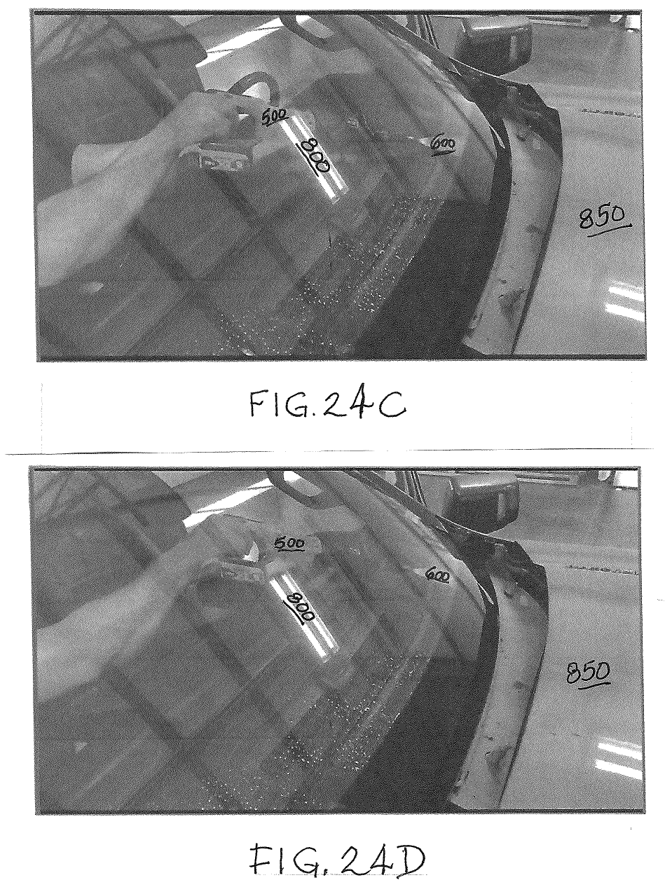

FIG. 16 is an end view of an embodiment of a quick-connect coupling 420b of the present subject matter, on an enlarged scale relative to FIGS. 14B, 15. The quick-connect coupling 420b has a six-sided or a hexagonal (also called a “hex”) insert 420c that allows each of the blades (FIG. 23) to have six different cutting positions or orientations relative to a windshield that is to be removed from a vehicle (see FIGS. 24A, 24B, 24C, and 24D).

FIG. 17 presents a side elevational view illustrating additional steps of a method for transforming an operational portion of a prior art reciprocating saw into a reciprocating apparatus, mechanism, or tool for removing a windshield from a vehicle, in accordance with the present subject matter. For instance, the hollow 350a of shaft 350 is an opening extending partially into the shaft 350 and oriented longitudinally along a central axis of the shaft 350. The size-reduced end portion 425a of the quick-connect coupling assembly 425 (FIG. 15) has been size-reduced, by design, to be snugly disposed within the hollow 350a of the shaft 350. The opening and internal sidewalls of hollow 350a have a geometric shape that prevents the size-reduced end portion 425a from rotating about the central axis of the quick-connect coupling assembly 425 relative to the upper gear housing 370.

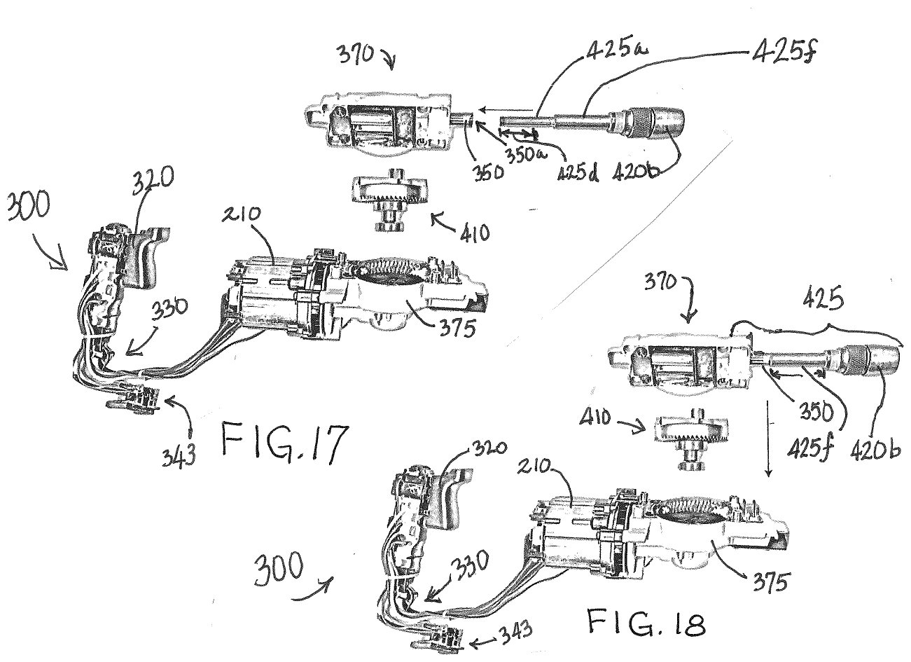

Thus, an additional step of a method for transforming the operational portion of a prior art reciprocating saw into an apparatus, mechanism, or tool for removing a vehicle windshield, in accordance with the present subject matter, includes disposing a major portion 425d (FIG. 17) of the size-reduced end portion 425a (FIG. 15) of the quick-connect coupling assembly 425 into the hollow 350a of the shaft 350 a sufficient distance, until an original-sized portion 425f of the shaft of the quick-connect coupling assembly 425 abuts an end portion of the shaft 350, as shown in FIG. 18. Furthermore, in embodiments, the quick-connect coupling assembly 425 of the present subject matter may be removably secured to upper gear housing 370, for example, by a frictional “interference fit” between the inner surfaces of the hollow 350a and the external surfaces of the size-reduced end portion 425a. In other embodiments, the quick-connect coupling assembly 425 could be fixedly secured to the shaft 350 of the upper gear housing 370, for example, by welding.

FIG. 18 presents a side elevational view illustrating a method for transforming a reciprocating saw into an apparatus, mechanism, or tool for removing a windshield from a vehicle, in accordance with the present subject matter, by securing the quick-connect coupling assembly 425 (FIG. 15) to the shaft 350 of the upper gear housing 370. Another step of a method for transforming a reciprocating saw into an apparatus, mechanism, or tool for removing a windshield from a vehicle, in accordance with the present subject matter, includes securing together the upper and lower gear housings 370 and 375, with the gear-and-cam assembly 410 of the present subject matter disposed therebetween.

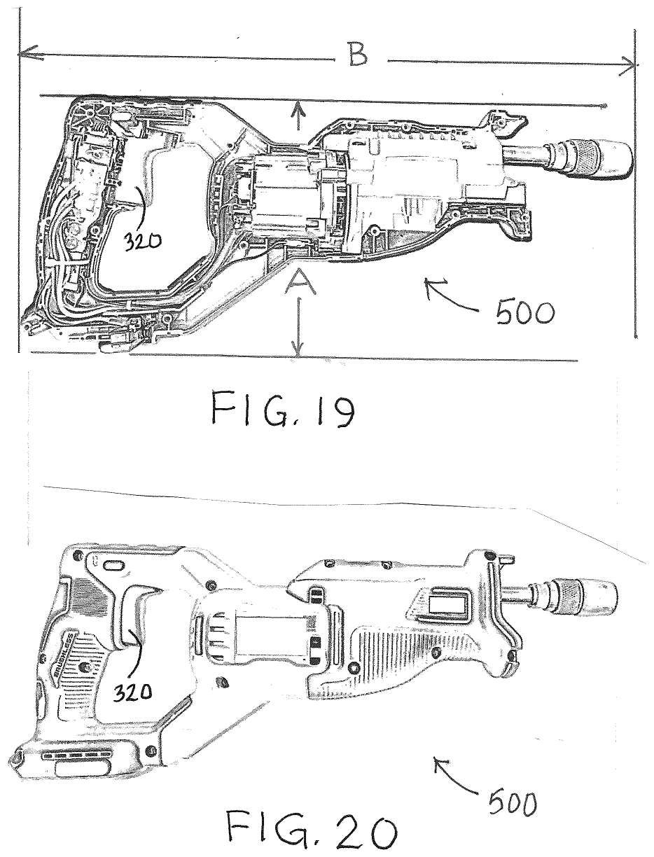

FIG. 19 is a side elevational view of an embodiment of a reciprocating apparatus, mechanism, or tool 500 for removing a vehicle windshield, in accordance with the present subject matter, where a majority of the internal components of the embodiment are visible.

FIG. 20 depicts the embodiment of the reciprocating apparatus, mechanism, or tool 500 for removing a windshield of a vehicle (e.g., a car, a van, a truck, and so forth), in accordance with the present subject matter, as this embodiment may appear to a user. Advantages and/or features of the reciprocating apparatus, mechanism, or tool 500 of the present subject matter—over competitive products—when a reciprocating apparatus, mechanism, or tool 500 of the present subject matter is used to remove a windshield of a vehicle (e.g., a car, a van, a truck, and so forth) are described in detail throughout this patent specification and presented in the drawing figures. The features and/or advantages of the reciprocating apparatus, mechanism, or tool 500 enable it to be relatively more compact, weigh less, and be less cumbersome, than a variety of vehicle windshield-removal products sold by competitors. An embodiment of the reciprocating apparatus, mechanism, or tool 500 (FIG. 20) of the present subject matter has an overall height value (“A”) of about 170.2 mm (about 6.7 in.), an overall length value (“B”) of about 438.2 mm (about 17.25 in.), and a weight (without battery) of about 2.39 kg. (about 5 lbs., 4.2 oz.).

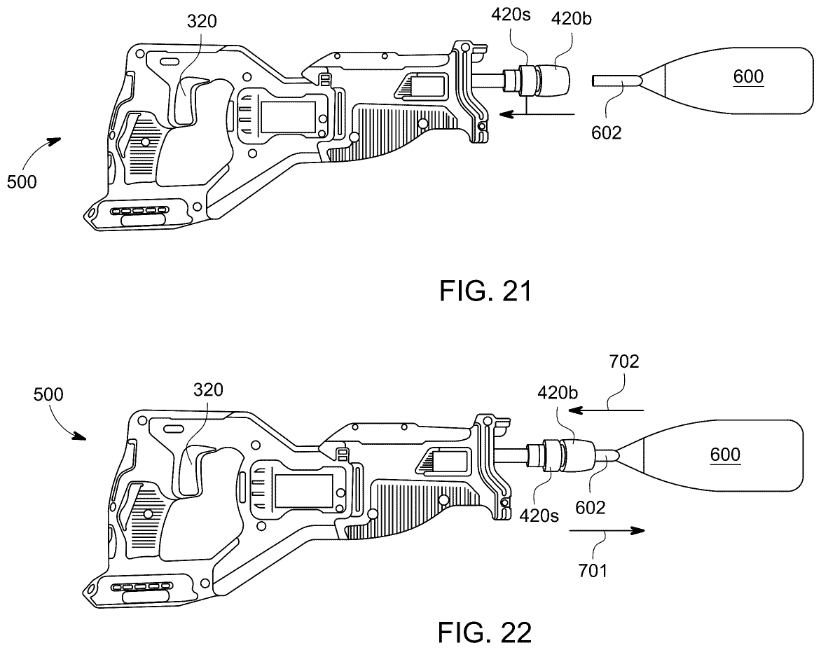

FIG. 21 is a side elevational view of an embodiment of a reciprocating mechanism or tool 500 (presented, e.g., in FIG. 20) of the present subject matter before a blade 600 (that has been designed, sized, adapted, and configured to remove a vehicle windshield) has been removably connected to the quick-connect coupling assembly 425 (presented in FIG. 15). The blade 600 includes a unitary stem 602 dimensioned and configured to snugly fit into an open end or insert 420c of a quick-connect coupling 420b (FIGS. 15, 16) after a slide component 420s (FIG. 21) of the quick-connect coupling 420b has been urged toward the tool 500 for permitting the stem 602 (of a blade 600) to be inserted into the open end (also called the insert 420c) of the quick-connect coupling 420b shown. The quick-connect coupling 420b contains internal spherical components (not shown) that are internally movable to enable the stem 602 to be inserted beyond the open end 420c and into the coupling 420b. The coupling 420b includes a spring (not shown) that urges the slide 420s away from the tool 500 and the stem 602 includes indentations dimensioned and configured to receive the internal spherical components mentioned in relation to the coupling 402b, to removably secure the stem 602 to coupling 420b. Details may be found in US 2012/0319399 to Schweizer et al., hereby incorporated by reference in its entirety.

FIG. 22 depicts a side elevational view of a reciprocating apparatus, mechanism, or tool 500 (exemplified by FIG. 20) after a blade 600—designed, configured, sized, and shaped to enable easy removal of a windshield from a vehicle (e.g., a car, van, or truck)—is removably secured to a quick-connect coupling assembly 425 (exemplified by FIG. 15). The custom cam 400 (FIG. 11B) of the present subject matter provides each reciprocating apparatus, mechanism, or tool 500 (see, e.g., FIG. 22) of the present subject matter with an additional feature and/or advantage that will now be described in detail. Commercially available reciprocating saws (see, e.g., FIGS. 1 through 5) are designed to extend their reciprocating saw component outwardly from the operational portion of the reciprocating saw apparatus in a first direction 101 (see, e.g., FIG. 3) by a distance that is no less than about 28.6 mm (about 1.125 in.) after which the saw blade component is withdrawn in a second or opposite direction 102 back to its original position. However, in sharp contrast, the custom-made cam 400 (FIG. 11B) of the present subject matter, after it has been secured to the main gear 396 (see, e.g., FIG. 13A) to become the gear-and-cam assembly 410 (see, e.g., FIG. 13B)—and after components shown in FIG. 18 have been assembled to produce the tool 500 shown in FIG. 20—causes the blade 600 to extend from the operational portion of the tool 500 by a distance of about 9.5 mm (about ⅜ in.) in a first direction 701 after which the blade 600 is withdrawn in a second or opposite direction 702 back to its original position. Thus, the design of custom cam 400 enables an end portion of the blade 600 of the reciprocating windshield removal tool 500 to move reciprocally in in a back-and-forth motion pattern designed to cause minimal damage to a vehicle, the windshield of which is to be removed. Hand pressure exerted by a user upon trigger 320 (see, e.g., FIGS. 6-9 and 17-22) controls the back-and-forth motion frequency of the blade 600. For instance, a minor amount of trigger-squeezing pressure may cause the blade 600 to extend-and-retract within a range of from about 100 times to about 500 times per minute, while a major amount of trigger-squeezing pressure may cause the blade 600 to extend-and-retract within a range of from about 3,000 times to about 8,000 times per min.

FIG. 23 depicts an embodiment of five differently shaped and dimensioned blades. Each blade has a stem 602b designed and configured to be inserted into a quick-connect coupling 420b (see, e.g., FIGS. 21, 22) of a reciprocating apparatus, mechanism, or tool 500 of the present subject matter. Each blade has a thickness of about 1.63 mm (about 0.064 in.) at its base and of about 1.22 mm (about 0.048 in) at its windshield-removing tip.

FIG. 23 depicts five differently shaped and dimensioned blades used in connection with the reciprocating apparatus, mechanism, or tool 500 of the present subject matter. These include a long blade, a medium blade, a short blade, and two panel blades. One of the panel blades is about 25.4 mm (about 1 in.) wide at its windshield-removing edge. The other panel blade is about 38.1 mm (about 1 & ½ in.) wide at its windshield-removing edge. The 1-in. panel blade has a length (“L1”) value of about 141 mm (about 5.55 in.); and the 1 and ½-inch panel blade also has a length (i.e., “L2” value) of about 141 mm (about 5.55 in.). The short blade has a width (“L11”) value at its windshield-removing edge of about 76.2 mm (about 3 in.) and a length (“L3”) value of about 76.2 mm (about 3 in.).

The medium and long blades each also have width (“L12” & “L13” respectively) values at their windshield-removing edges of about 76.2 mm (about 3 in.). Also, medium blades have a length (“L4”) value of about 139.7 mm (about 5.5 in.); and each long blade has a length (“L5”) value of about 208.3 mm (about 8.2 in.). Each of the five blades has a six-sided or a hexagonal (also called a “hex”) stem 602a that is about 50.8 mm (about 2 in.) long and 11.11 mm (about 0.4375 in.) between opposed flat sides (aka “flats”). (See FIG. 23C.). In embodiments, each stem 602a has indentations sized and configured to receive the internal spherical components mentioned above in relation to coupling 402b, to removably secure stem 600, 602a to coupling 420b (FIG. 22). Each blade shown has a neck disposed between, and unitary with, its stem and its windshield-removing portion.

The long and medium blades each include a neck 602b and 602c, respectively, having a width (“L6” & “L7”) value of about 33 mm (about 1.3 in.). The short blade includes a neck 602d having a width (“L8”) value of about 36.9 mm (about 1.45 in.). [Note: Blades in FIG. 23 are not drawn to scale.] The 1 & ½-in. panel blade includes a neck 602e having a width (“L9”) value of about 16 mm (about 0.63 in.). The 1-in. panel blade includes a neck 602f having a width (“L10”) value of about 14 mm (about 0.55 in.). Each neck (602b, 602c, 602d, 602e, 602f) has a height (“L15”) value of about 25.4 mm (about 1 in.).

FIGS. 23A, 23B, and 23C depict another embodiment for blade stems of FIG. 23. For instance, FIG. 23A presents a front elevational view of a blade 600 embodying principles of the present subject matter, while FIG. 23B presents a side elevational view of blade 600 shown in FIG. 23A (when rotated about its neck 602 by about 90 degrees).

FIG. 23C—a view from the plane 23C—23C in FIG. 23A—is an underside view of the embodiment of the neck 602 shown in FIG. 23A. Note that the connection of the neck 602 to the blade 600, as shown in FIG. 23A, presents the same side view of the neck 602 as is shown in FIG. 23 to present a side view of the necks 602a shown therein, even though the blades in FIG. 23 are presented frontally, while the blade 600 shown in FIG. 23B—which is a view taken from a linearly marked region identified by directional lines 23B—23B found above and below FIG. 23A—is shown as an on-edge embodiment.

Several embodiments of ways to secure a neck to a blade may be necessary to effectively and efficiently separate a vehicle windshield from a vehicle in difficult-to-reach locations. FIG. 23C present the six sides of a neck 602. For purposes of providing a detailed disclosure, the sides are identified as S1, S2, S3, S4, S5, and S6. Note that only three sides (i.e., S1, S2, and S3) of hexagonal neck 602 are seen when viewing the side elevational view of FIG. 23A, while four sides (S1, S2, S5, and S6) are seen in FIG. 23B.

FIGS. 24A, 24B, 24C, and 24D collectively present a series of views, showing the reciprocating apparatus, mechanism, or tool 500 of the present subject matter being used by a vehicle windshield removal technician, for the purpose of separating a lower portion of the windshield 800 of a vehicle 850 from the vehicle body. The technician, by using his right hand to hold the tool and squeeze its trigger (not shown) to operate the tool 500 and supporting the tool 500 with the palm of his left hand, is shown beginning the windshield removal operation by using reciprocating action of the blade 600 to operatively “work” the blade 600 into material (not visible) between a lower edge-margin portion of windshield 800 and the vehicle body, beginning at the right-edge portion (or passenger side) of the windshield 800 (FIG. 24A) and progressively operatively “working” the blade 600 toward (FIG. 24B) the left-edge portion (or driver's side) of the vehicle 850. FIG. 24C illustrates two-handed progress by the technician at the driver-side of the windshield 800. FIG. 24D demonstrates a one-armed stretch by the technician at the driver's side of vehicle 850. This procedure is repeated along the lower edge margin, the side edge margins, and the upper edge margin of the vehicle windshield as many times as necessary to separate the windshield from the body of the vehicle. Technicians in this field have been observed to be able to easily operatively “work” the blade 600 into material (not visible) between all edge-margin portions of the windshield 800 and the vehicle body, between the opposite edge portions of the windshield 800 and progressively operatively “work” the blade 600 into material (not visible) between the entire edge-margin portion of the windshield 800 and the vehicle body due to the power, the compactness, and the light weight of tool 500.

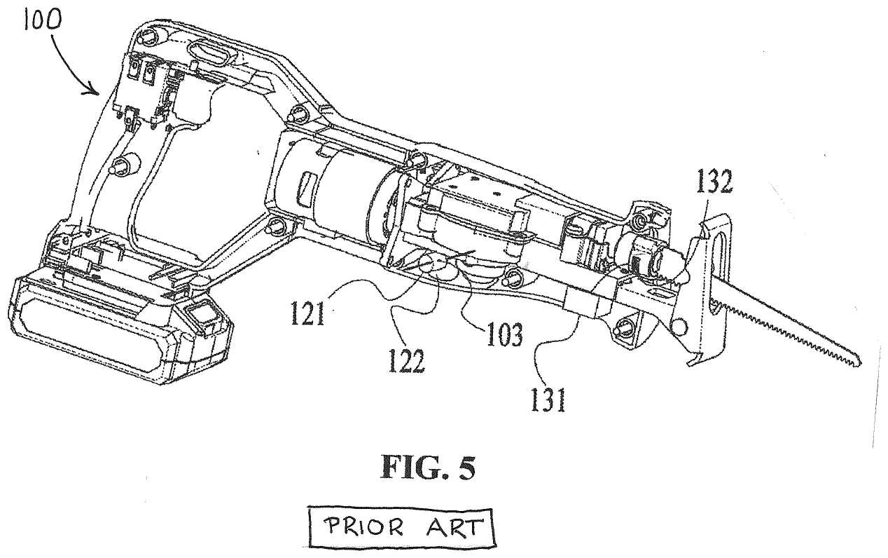

A method for transforming or converting a reciprocating saw into a reciprocating apparatus, mechanism, or tool 500 for removing a windshield 800 from a vehicle 850, in accordance with the present subject matter, includes a series of steps. The reciprocating saw 100 includes a saw blade (FIG. 5) and a blade guard 310 (FIG. 6). One of the steps of the method for transforming or converting a reciprocating saw (FIGS. 1-3 and 5) into the reciprocating apparatus, mechanism, or tool 500 noted above (FIGS. 19, 20) includes removing the saw blade and the blade guard 310 from the reciprocating saw 100. Another step involves cutting the blade guard 310 into two portions. One of the portions is a blade guard portion 310A. The other is an end cap portion 310B (FIG. 7). Another step involves attaching end cap portion 310B to the underside of a housing for a reciprocating-action assembly 340. Additional steps are to make a custom cam 400 (FIG. 11B), substitute the custom cam 400 for a prior art cam 394 (FIG. 11A), secure (preferably by welding) the custom cam 400 to a known main gear 396 (FIGS. 10, 12, 13A) to make a gear-and-cam assembly 410 (FIG. 13B). Another step is to remove a prior art coupling 360a (FIG. 14A) from an output shaft 350 (FIG. 14A) of the reciprocating-action assembly 340 (FIG. 8). Another step involves transforming a conventional quick-connect coupling assembly 420 (FIG. 14B) into a custom quick-connect coupling assembly 425 having a size-reduced end portion 425a that snugly fits into a central hollow 350a (FIG. 15) of output shaft 350.

What has been described in detail throughout this patent specification and shown in the accompanying drawing figures is a reciprocating apparatus, mechanism, or tool for removing a vehicle windshield from the vehicle. Also described in detail throughout this patent specification and shown in the accompanying figures is a method for transforming or converting a common reciprocating saw apparatus, mechanism, or tool into a novel reciprocating apparatus, mechanism, or tool for removing a vehicle windshield from a vehicle. While the present subject matter has been described with reference to exemplary embodiments, the present subject matter is not limited to the embodiments shown and described herein. On the contrary, alternatives, changes, or modifications will be apparent to a person of ordinary skill in the art after this patent specification and its figures are reviewed. So, alternatives, changes, and/or modifications will be treated as forming a part of the present subject matter insofar as they fall within the spirit and scope of the claims.

I claim:

1. An apparatus for removing a vehicle windshield from a vehicle, wherein the apparatus comprises:
a vehicle windshield-removing portion including a blade having an edge adapted and configured to be inserted between an edge margin of a vehicle windshield and a vehicle body spaced adjacent to the windshield edge margin, and
an operational portion including a reciprocating mechanism having an extendable and retractable shaft operatively connected to the blade, for enabling the blade to reciprocally move between the edge margin of the vehicle windshield and the vehicle body for removing the vehicle windshield from the vehicle body.

2. The apparatus of claim 1, wherein the reciprocating mechanism includes a cam dimensioned and configured for causing the shaft to move from a first position to a second position, wherein a distance between the first and second positions is about 9.5 mm.

3. The apparatus of claim 2, wherein the reciprocating mechanism further includes a quick-connect coupling assembly having a size-reduced end portion that fits into an opening at an end portion of the extendable and retractable shaft.

4. A method for transforming a reciprocating saw into a reciprocating apparatus for removing a vehicle windshield from a vehicle, comprising:
removing a saw blade and a blade guard from the reciprocating saw;
cutting the blade guard into two portions, wherein one of the two portions is a blade guard portion and the other one of the two portions is an end cap portion;
attaching the end cap portion to an underside of a housing of a reciprocating-action assembly, wherein the assembly includes an extendable and retractable shaft 4 operatively connected to a reciprocally operating mechanism of the assembly;
making a cam;
securing the cam to a gear to make a gear-and-cam assembly; and
dimensionally altering an end portion of a quick-connect coupling assembly, for enabling the dimensionally altered end portion of the quick-connect coupling assembly to fit into an opening at an end portion of the shaft.

5. The method of claim 4, further including reciprocally moving the shaft between a first position and a second position, wherein a distance between the first and second positions is about 9.5 mm.

6. The method of claim 4, wherein the cam is secured to the gear by welding.
